(19) United States
(12) Patent Application Publication
(10) Pub. No.: US 2004/0213445 A1
(43) Pub. Date: Oct. 28, 2004

(54) Method and apparatus for separating an object from an ultrasound image

(75) Inventors: Min Hwa Lee, Seoul (KR); Sang Hyun Kim, Seoul (KR); Seok Bin Ko, Seoul (KR); Arthur Gritzky, Seoul (KR); Eui Chul Kwon, Seoul (KR)

Correspondence Address: Frank Chau, Esq., F. CHAU & ASSOCIATES, LLC, Suite 501, 1900 Hempstead Turnpike, East Meadow, NY, 11554, US

(73) Assignee: MEDISON CO., LTD.

(21) Appl. No.: 10/849,419

(22) Filed: May 19, 2004

Related U.S. Application Data
(63) Continuation-in-part of application No. 09/658,028, filed on Sep. 8, 2000.

(30) Foreign Application Priority Data
Sep. 9, 1999 (KR) 1999-38346

(51) Int. Cl. G06K 9/00

(52) U.S. Cl. 382/128

(57) ABSTRACT

An object separating method separates a target object from an ultrasound image. Specifically, first of all, a set of two dimensional (2D) ultrasound images are combined to provide volume data. Then, a rotational axis to rotate the volume data and two points as reference points are set, wherein the two points are points where the rotational axis and the target object intersect. Thereafter, the volume data is rotated by a predetermined angle around the rotational axis to generate a 2D ultrasound image for each rotated angle, wherein the rotating process is repeatedly performed until the volume data is rotated by a preset angle. A contour of each 2D ultrasound image is extracted and vertices on the contour are set to thereby provide contours with vertices. The vertices of each of the contours are wired and processed to provide a 3D image of the target object.

This application is a continuation-in-part of application Ser. No. 09/658,028, filed on Sep. 8, 2000.

### FIELD OF THE INVENTION

The present invention relates to a three-dimensional ultrasound imaging system. Specifically, the invention relates to a method and apparatus for effectively separating an object from an ultrasound image.

### BACKGROUND OF THE INVENTION

In general, an ultrasound image testing apparatus transmits an ultrasound image signal to an object to be tested, and receives a returned ultrasound image signal reflected from a discontinuous plane of the object. Then, the received ultrasound image signal is processed to test an internal status of the object. This ultrasound image testing apparatus is widely used in various fields such as medical diagnosis, non-destructive testing, underwater detection, and so on.

Meanwhile, there are two existing methods for measuring a volume of a target object of an ultrasound image, for use in the testing apparatus.

In the first method, a contour of a target object is traced in all transverse sections of an ultrasound image and an area of each of all the transverse sections is obtained. Then, a volume of the target object is calculated based on the area and a thickness of each transverse section.

FIG. 1 shows an example of calculating the volume at the continuous transverse sections, wherein a volume of prostate of a man is illustrated. First, a prostate area of all cross-sections at transverse sections of the prostate is measured based on ultrasound images photographed at interval of 0.5 cm. Then, the volume of prostate is obtained by multiplying the prostate area by the thickness of 0.5 cm. This method can be represented as follows:

V=0.5×(S1+S2+. . . +S5) Eq. (1)

wherein V denotes the volume of the prostate and S indicates the surface area of the prostate at each transverse section. The surface area is calculated in such a manner that an observer draws a contour line of the prostate manually by using a mouse on a screen where an ultrasound image is displayed, and calculates an area based on the drawn contour line. Using the first method, a very accurate volume can be obtained. However, since the contour should be traced manually with respect to all the traverse sections, there is required much time to obtain the volume.

In the second method, a contour is traced only with respect to a maximum transverse section and its area is calculated, in order to measure a volume of a particular internal organ of a human body by using an ultrasound image. Then, a shape of the internal organ is assumed an ellipse, and thereafter the volume in the case that the maximum transverse section is rotated with respect to the long axis is calculated according to a defined formula. This method is called a one-section rotation ellipse approximation method. When an area at the maximum transverse section is S, and the long axis is X, the volume V of the rotational elliptical body is obtained by rotating the ellipse of the area S around the long axis X which is set as the rotational axis. The defined formula is represented as follows:

$$V = \frac{8 {S}^{2}}{3 π X} \qquad Eq . ( 2 )$$

In the second method, since only one time manual trace is performed in order to calculate the volume using the defined formula, quick processing is possible but its accuracy is very low. Moreover, the both mentioned methods do not separate a target object from an ultrasound image and also do not visualize separated object. Consequently, an observer cannot view a three dimensional shape of the target object.

One of various prior arts is disclosed in U.S. Pat. No. 5,601,084. The patent provides a diagnosis method that depends on a change of thickness of walls (i.e., inner wall and outer wall) of a cardiac. In such a method, each wall's change is analyzed by manually drawing contour lines of an inner and an outer walls of the cardiac with respect to each cross-section cardiac image and also by using each contour information so obtained. Thus, the patent has a shortcoming that the operator manually draws contour lines with respect to all cross-section cardiac images to obtain the contour information.

### SUMMARY OF THE INVENTION

To solve the above problems, it is an object of the present invention to provide a method and apparatus for quickly separating a target object from an ultrasound image, and visualizing the separated object in a three dimensional image.

In accordance with one aspect of the present invention, there is provided a method of separating a target object from an ultrasound image, comprising the steps of: combining a set of two dimensional (2D) ultrasound images to provide volume data; setting a rotational axis to rotate the volume data and two points as reference points, wherein the two points are points where the rotational axis and the target object intersect; rotating the volume data by a predetermined angle around the rotational axis to generate a 2D ultrasound image for each rotated angle, wherein the rotating process is repeatedly performed until the volume data is rotated by a preset angle; extracting a contour of each 2D ultrasound image and setting vertices on the contour to thereby provide contours with vertices; and wiring and processing the vertices of each of the contours to provide a 3D image of the target object.

In accordance with another aspect of the present invention, there is provided an apparatus for separating a target object from an ultrasound image, comprising: means for combining a set of two dimensional (2D) ultrasound images to provide volume data; means for setting a rotational axis to rotate the volume data and two points as reference points, wherein the two points are points where the rotational axis and the target object intersect; means for rotating the volume data by a predetermined angle around the rotational axis to generate a 2D ultrasound image for each rotated angle, wherein the rotating process is repeatedly performed until the volume data is rotated by a preset angle; means for extracting a contour of each 2D ultrasound image and setting vertices on the contour to thereby provide contours with vertices; and means for wiring and processing the vertices of each of the contours to provide a 3D image of the target object.

### BRIEF DESCRIPTION OF THE DRAWINGS

The above and other advantages of the present invention will become more apparent by describing the preferred embodiment thereof in more detail with reference to the accompanying drawings in which:

FIG. 1 shows an example diagram showing the volume at the continuous transverse sections using an ultrasound image according to a conventional volume measuring method;

FIG. 2 is a block diagram showing an apparatus for separating a target object from an ultrasound image, and visualizing the separated object in a three dimensional image in accordance with an embodiment of the present invention;

FIG. 3 depicts a rotational axis and reference point setting status for separating an object from an ultrasound image in accordance with the present invention;

FIG. 4A offers an example of an observatory window for automatic contour extraction in accordance with the invention;

FIG. 4B shows a binarized image for automatic contour extraction in accordance with the invention;

FIG. 4C provides a binarized image from which small areas are removed for automatic contour extraction in accordance with the invention;

FIG. 4D shows a post-processed resultant image for automatic contour extraction in accordance with the invention;

FIG. 5 depicts a contour extracted with respect to a certain plane and vertices in the extracted contour in accordance with the invention;

FIG. 6 shows a wire frame for graphic processing using the vertices;

FIG. 7 provides a combined three-dimensional image; and

FIG. 8 shows steps of describing details of the automatic contour extractor 31 shown in FIG. 2.

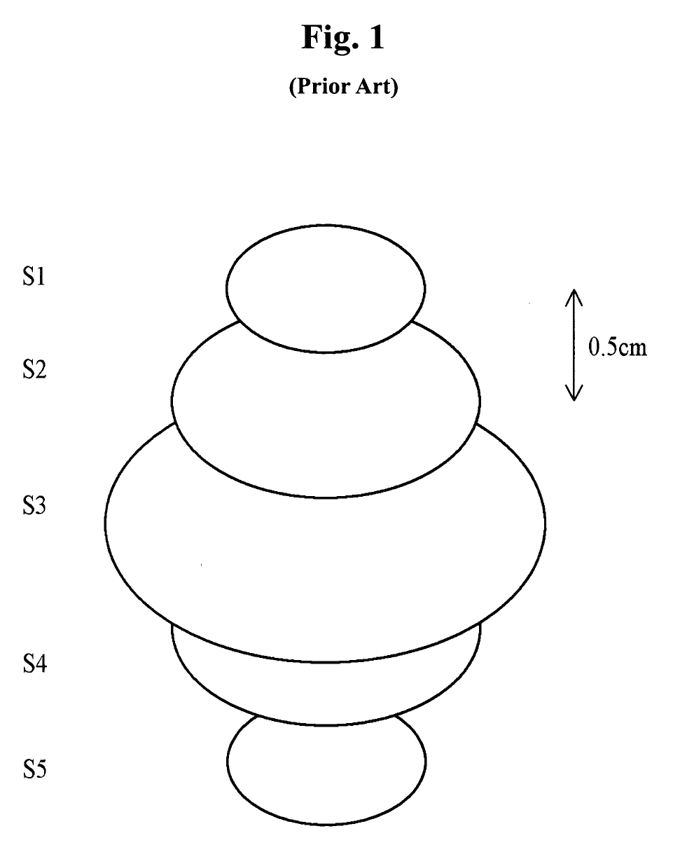

### DETAILED DESCRIPTION OF THE PRESENT INVENTION

Now, a preferred embodiment of the present invention will be described with reference to the accompanying drawings.

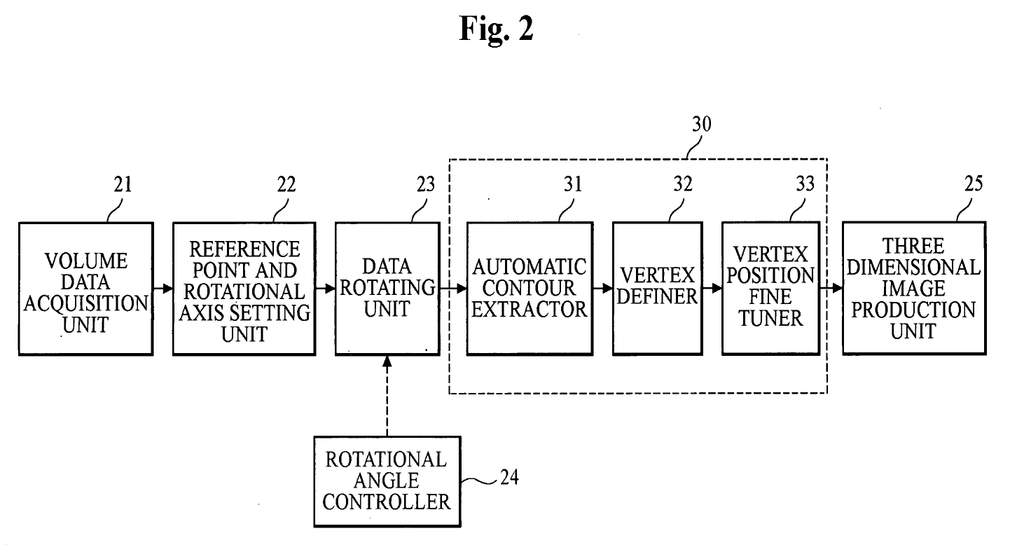

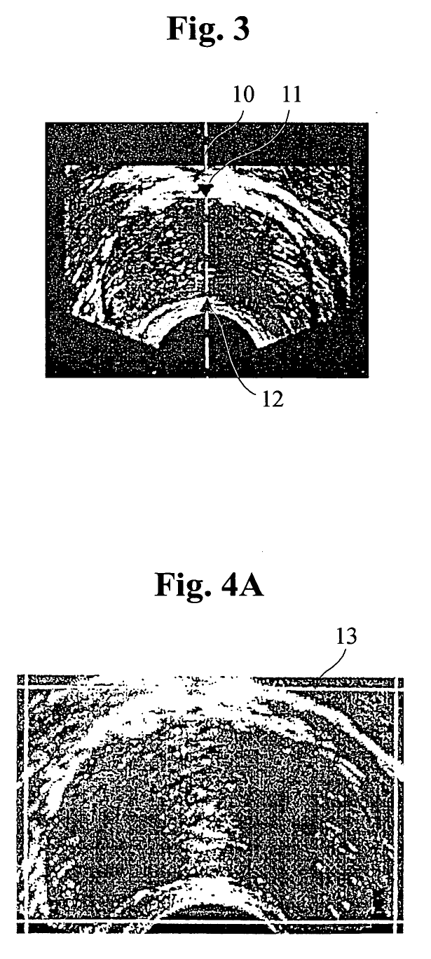

Referring to FIG. 2, an object separating apparatus in accordance with the present invention comprises a volume data acquisition unit 21 for receiving and combining a set of two dimensional (2D) ultrasound images, to thereby obtain volume data. It should be noted that the number of 2D ultrasound images in the set can be decided based on size of an object to be separated. A reference point and rotational axis setting unit 22, which is operated by an operator's instruction, sets a rotational axis to rotate the volume data and also sets two points where the rotational axis and a target object intersect as reference points. The target object may be an arbitrary object which is made by setting any point on the volume data while the operator views it on a display (not shown) for separating, and the two points are set to have an identical distance from a center point of the volume data, respectively. FIG. 3 depicts an illustrative method for setting a rotational axis and reference points on a reference image of the set of 2D ultrasound images, wherein it is assumed that the vertical line 10 is set as the rotational axis and two triangles 11 and 12 thereon denote the reference points.

A data rotating unit 23 rotates the volume data by a predetermined angle around the rotational axis 10 under the control of a rotational angle controller 24. The rotational angle controller 24 outputs a control signal for rotating the volume data by a predetermined angle to the data rotating unit 23. In response to the control signal, the data rotating unit 23 rotates the volume data by each identical predetermined angle and produces a 2D ultrasound image at a respective angle.

Also, the inventive apparatus comprises a contour extraction unit 30 for extracting a contour of a 2D image with respect to the plane at each rotated angle and defining vertices to be used later for graphic processing on the extracted contour. As shown, the contour extraction unit 30 includes an automatic contour extractor 31, a vertex definer 32 and a vertex position fine tuner 33. The contour extraction process in the contour extraction unit 30 of the present invention will be described in detail below.

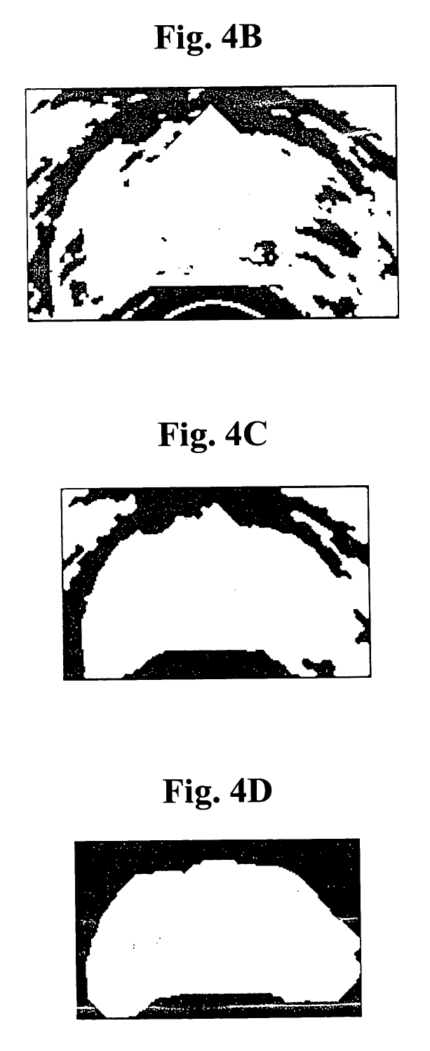

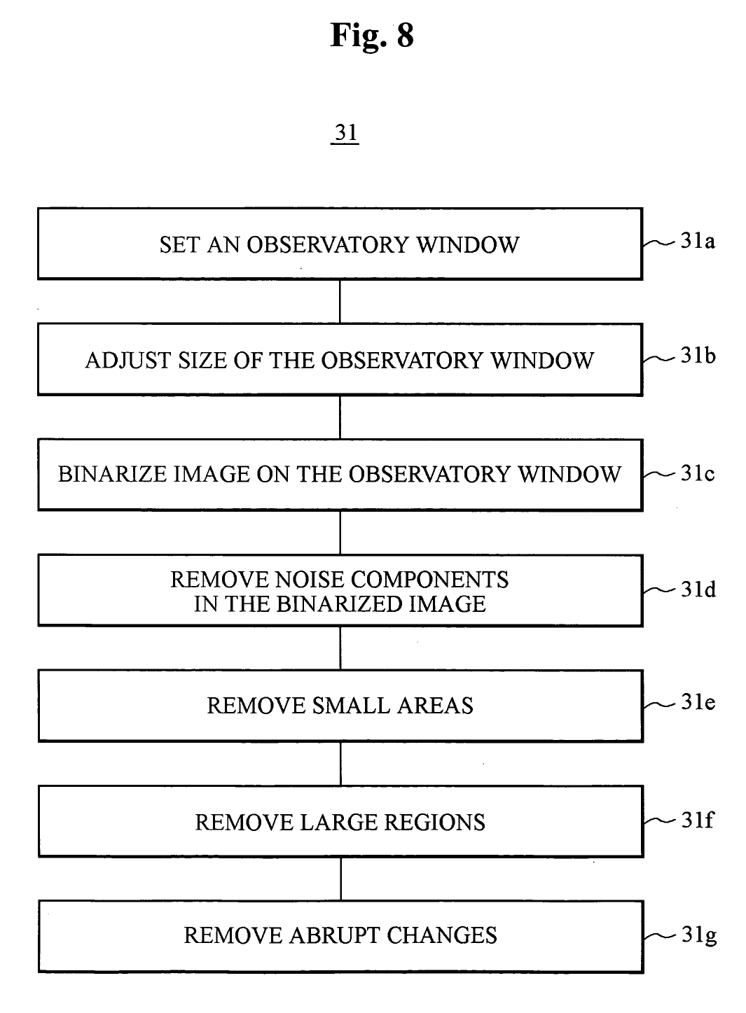

First of all, the automatic contour extractor 31 automatically sets an observatory window 13 showing a boundary region of the target object in each rotated 2D ultrasound image obtained by the data rotating unit 23 (see FIG. 4A). In a preferred embodiment of the invention, it is assumed that the reference image of the volume data stands for an image which has not been rotated in the set of 2D ultrasound images, and the target object from which a contour is extracted exists in all 2D ultrasound images which are obtained by sequentially rotating the volume data by respective rotated angles around the rotational axis 10 shown in FIG. 3. Specifically, referring to FIG. 8, in step 31a a rectangular for estimating lengths of the top and bottom and the left and right of the target object based on the reference points is defined as the observatory window 13. With this automatic setting of the observatory window 13, it is possible to minimize a size of whole region to be calculated and decrease time spent for the object separation. Then, in step 31b, the size of the observatory window 13 is adjusted to have a small margin in contour information of the target object obtained at the reference image, with respect to a next image obtained by rotating the volume data by a predetermined angle. This process is repeated until the volume data is completely rotated by 360°. As shown in FIG. 4A, the observatory window 13 is set to be larger than the size of the target object.

Thereafter, in step 31c, binarization process for separating the target object from the 2D ultrasound image of each rotated angle is adaptively carried out by using, for example, a known Otsu's threshold technique. The above-described observatory window has the approximate size of the target object, and thus, the binarization process is not applied to the whole image but applied within only an image on the observatory window, where FIG. 4B shows a binarized image. The binarized image as shown in FIG. 4B includes a number of noise components. Thus, in next step 31d, a morphological filter is used in order to remove the noise components.

By filtering the binarized image using the morphological filter, the noise components can be considerably reduced. However, there still exist small areas, which are noise components, in the binarized image. Thus, these small areas should be removed in order to extract the target object from the binarized image. In accordance with the invention, for removing the small areas, in step 31e bright areas within the binarized image are extracted and labeled as any values through the use of a Raster scanning method. Then, a size of each bright area is measured on a pixel-by-pixel basis and compared with a preset threshold value to decide as to whether or not each bright area is small area. Among the bright areas, all bright areas which are smaller than the preset threshold value are decided as small areas and then removed by zero-masking them. The preset threshold value may be decided and also changed based on a distance between the two reference points set previously.

FIG. 4C shows a binarized image from which the small areas have been removed but includes several large areas. For their removal, in step 311f a morphological filtering is again performed, thereby obtaining the binarized image from which the large areas have been removed. In the morphological filtering, there are carried out two processes: erosion and dilation. The erosion process separates a region having the target object from the binarized image resulted from step 31f by using, for example, 15×15 masking technique, wherein unnecessary regions including noise components are removed by setting a desired region on the basis of information of the reference points and the center point of the volume data. By this erosion process, however, there may be any eroded parts in the target object. In such a case, in accordance with the present invention, the dilatation process is performed to recovery an original shape of the target object.

FIG. 4D shows the target object resulting from post-processing such as filtering, in which a boundary of the extracted target object is determined as a contour of that object. Here, a number of abrupt changes exist on the boundary of the extracted target object. To remove those abrupt changes, in step 31g a smoothing filtering is operated along the boundary of the extracted target object by using, for instance, a Gaussian averaging filter, to thereby make the boundary thereof smooth.

Referring back to FIG. 2, the vertex definer 32 selects the vertices at a predetermined interval on the contour line of the target object. FIG. 5 shows a contour which is automatically extracted with respect to a certain plane and the vertices in the extracted contour. The automatically extracted contours and vertices of the target object may not be completely consistent with the contour of the original object. Thus, the vertex position fine tuner 33 fine-tunes the position of the automatically extracted vertices in order to make them consistent with the contour of the original object in response to the operator's instruction.

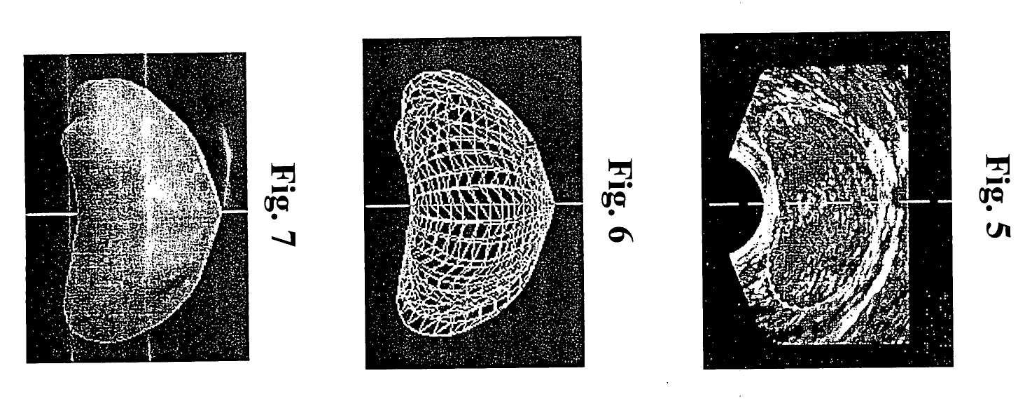

A three dimensional (3D) image forming unit 25 forms a wired frame by wiring the vertices defined in the contour extraction unit 30 and provides a 3D image of the object using a computer graphic technique (see FIG. 6). A shading or quality mapping of the computer graphic is further applied to the 3D image, to thereby produce the 3D image as shown in FIG. 7 on a display (not shown).

As described above, the present invention defines the rotational axis, rotates the volume data around the rotational axis, acquires the contour of the target object, and separates the target object from the 2D image. That is, the present invention sets the rotational axis and reference points only on the reference image of the set of 2D images once, not on all the 2D images in the set. In accordance with the invention, a contour is automatically extracted and the extracted contour is fine-tuned in response to the operator's instruction, to thereby obtain final contour information. Accordingly, the ultrasound image apparatus according to the present invention can quickly and accurately separates the target object from the image. Moreover, the extracted target object can be visualized in 3D pattern based on the extracted information, to thereby view the shape of the object without having a physical treatment such as a surgery operation. It is also possible to display the shape of the 2D cross-section in the case that the object has been cut at a certain angle. Since the present invention has the shape information of the 3D object additionally, the volume of the apparatus necessary for diagnosis can be obtained without making a particular additional calculation.

While the present invention has been described and illustrated with respect to preferred embodiments of the invention, it will be apparent to those skilled in the art that variations and modifications are possible without deviating from the broad principles and teachings of the present invention. For example, the present invention can be applied equally to a case for analyzing various pains other than arthritic pain.

What is claimed is:

1. A method of separating a target object from an ultrasound image, comprising the steps of:
combining a set of two dimensional (2D) ultrasound images to provide volume data;
setting a rotational axis to rotate the volume data and two points as reference points, wherein the two points are points where the rotational axis and the target object intersect;
rotating the volume data by a predetermined angle around the rotational axis to generate a 2D ultrasound image for each rotated angle, wherein the rotating process is repeatedly performed until the volume data is rotated by a preset angle;
extracting a contour of each 2D ultrasound image and setting vertices on the contour to thereby provide contours with vertices; and
wiring and processing the vertices of each of the contours to provide a 3D image of the target object.

2. The method of claim 1, wherein the rotational axis and the two points are set on a reference image of the set of 2D ultrasound images.

3. The method of claim 2, wherein the contour extracting step comprises the steps of:
setting an observatory window showing an approximate position and size of each rotated 2D ultrasound image;
adjusting the size of the observatory window the size of the observatory window to have a small clearance in contour information of the target object obtained at the reference image, with respect to a next image obtained by rotating the volume data by the predetermined angle;
binarizing an image on the observatory window; and
removing noise components included in the binarized image.

4. The method of claim 1, wherein the extracting step comprises a step of selecting the vertices at a predetermined interval on contour line of the target object and fine-tuning the contour line for positions of the vertices to be consistent with an original shape of the target object.

5. The method of claim 1, further comprising a step of displaying the 3D image of the target object.

6. An apparatus for separating a target object from an ultrasound image, comprising:
means for combining a set of two dimensional (2D) ultrasound images to provide volume data;
means for setting a rotational axis to rotate the volume data and two points as reference points, wherein the two points are points where the rotational axis and the target object intersect;
means for rotating the volume data by a predetermined angle around the rotational axis to generate a 2D ultrasound image for each rotated angle, wherein the rotating process is repeatedly performed until the volume data is rotated by a preset angle;
means for extracting a contour of each 2D ultrasound image and setting vertices on the contour to thereby provide contours with vertices; and
means for wiring and processing the vertices of each of the contours to provide a 3D image of the target object.

7. The apparatus of claim 6, wherein the rotational axis and the two points are set on a reference image of the set of 2D ultrasound images.

8. The apparatus of claim 7, wherein the contour extraction means comprises:
means for setting an observatory window showing an approximate position and size of each rotated 2D ultrasound image;
means for adjusting the size of the observatory window the size of the observatory window to have a small clearance in contour information of the target object obtained at the reference image, with respect to a next image obtained by rotating the volume data by the predetermined angle;
means for binarizing an image on the observatory window; and
means for removing noise components included in the binarized image.

9. The apparatus of claim 6, wherein the extracting means comprises means for selecting the vertices at a predetermined interval on contour line of the target object and fine-tuning the contour line for positions of the vertices to be consistent with an original shape of the target object.

10. The apparatus of claim 6, further comprising means for displaying the 3D image of the target object.
